(19) United States
(12) Patent Application Publication
(10) Pub. No.: US 2016/0210801 A1
(43) Pub. Date: Jul. 21, 2016

(54) Methods and Apparatus for an Electronic Drop Safe

(71) Applicant: Bob M. Dobbins, Villanova, PA (US)

(72) Inventor: Bob M. Dobbins, Villanova, PA (US)

(73) Assignee: ELLENBY TECHNOLOGIES, INC, Woodbury Heights, NJ (US)

(21) Appl. No.: 14/598,337

(22) Filed: Jan. 16, 2015

(51) Int. Cl. G07D 7/00; G07D 11/00

(52) U.S. Cl. CPC G07D 7/00; G07D 11/0069

(57) ABSTRACT

Systems and techniques for providing an improved electronic safe are described. An electronic safe is provided with both a drop safe mode of operation in which cash is determined to be acceptable by a bill acceptor or validator and then stacked in a cash storage device internal to the safe, and an acceptability test mode in which cash is tested for acceptability and then returned to a user with an indication of the outcome of that test.

### CROSS-REFERENCE TO RELATED APPLICATION

The present application is related to U.S. application Ser. No. 12/899,219 filed Oct. 6, 2010, now abandoned, which is a divisional of U.S. application Ser. No. 11/474,206 filed Jun. 23, 2006, now abandoned, which is a divisional of U.S. application Ser. No. 09/960,595 filed Sep. 21, 2001, now abandoned, which in turn claims the benefit of U.S. Provisional Application Ser. No. 60/234,133 entitled “Methods and Apparatus for an Electronic Drop Safe” filed Sep. 21, 2000. It is also related to U.S. application Ser. No. 12/403,029 filed Mar. 12, 2009, now U.S. Pat. No. 7,779,983, which is a divisional of U.S. application Ser. No. 10/912,753 filed Aug. 5, 2004, now U.S. Pat. No. 7,516,832, which claims the benefit of U.S. Provisional Application Ser. No. 60/496,515 filed Aug. 20, 2003, all of which are entitled “Two Door Electronic Safe”. It is also related to U.S. application Ser. No. 14/293,431 filed Jun. 2, 2014, which is a continuation of U.S. application Ser. No. 13/753,119 filed Jan. 29, 2013, now U.S. Pat. No. 8,770,372, which claims the benefit of U.S. Provisional Application Ser. No. 61/594,445 filed Feb. 3, 2012, all of which are entitled “Coin and Bill Dispensing Safe”. It is also related to U.S. application Ser. No. 14/302,555 filed Jun. 12, 2014, which claims the benefit of U.S. Provisional Application No. 61/834,120 filed Jun. 12, 2013, both of which are entitled “Method and Apparatus for Mobile Cash Transportation”. All of the above identified related applications are incorporated by reference herein in their entirety.

### FIELD OF THE INVENTION

The present invention relates generally to improvements in electronic safes. More particularly, the present invention relates to improvements in electronic safes, such as electronic drop safes, employing electronic bill validators to provide an additional counterfeit detection mode of operation as addressed further below.

### BACKGROUND OF THE INVENTION

Many retail businesses have at least one electronic drop safe on site. Particularly in high cash flow transaction businesses, cashiers are required to limit the amount of cash stored in the cash drawers to a predetermined amount. This requirement may be in place twenty-four hours a day, seven days a week, or during a predetermined range of time, such as late evening and early morning hours. For example, a convenience store may employ an electronic drop safe between 10 PM and 6 AM. As a further alternative, all big bills, such as U.S. $50 and $100 bills may be dropped at all times.

Such electronic drop safe products are typical in high cash flow transaction businesses. These electronic drop safes have one or more bill acceptors that can determine the denomination of bills as they are inserted into the bill acceptors and store those bills in a cassette inside the drop safe. The use of electronics and bill acceptors to recognize bills also allows the reporting and tracking of money by cashier, shift and day easier to do automatically. These electronic drop safes reduce the time the manager must spend to do the counting manually, and also reduce the amount of time the money has to be exposed during those times that the money was removed from the safe to be transferred to a bank or other secured location.

More recently, electronic safe technology has been advantageously adapted for mobile cash transportation as discussed in U.S. application Ser. No. 14/302,555 filed Jun. 12, 2014 and incorporated by reference herein in its entirety.

Additionally, electronic currency validators have also been employed in a coin and bill dispensing safe, by the assignee of the present patent application, as described in detail in U.S. application Ser. No. 13/753,119 filed Jan. 29, 2013, now U.S. Pat. No. 8,770,372, and U.S. application Ser. No. 14/293,431 filed Jun. 2, 2014, both of which are incorporated by reference herein in their entirety.

In all of the above safe products, while the currency validator or bill acceptor will reject currency not recognized as valid, any currency that tests as valid is then accepted and stacked in a stacker associated with the validator. In the case that the associated stacker is full, the currency inserted is no longer tested, as the bill acceptor is disabled when the stacker is full. Cash, such as small bills, that the retailer wants in the cash drawer for making change are not tested for validity as that cash is simply placed in the cash drawer without testing.

### SUMMARY OF THE INVENTION

Among its several aspects, the present invention recognizes that with the increased use of high denomination currency, such as U.S. $20, $50 and $100 bills, merchants would like a low cost and more effective alternative to the marking pens and other low cost approaches to counterfeit detection.

It is an object of the present invention to provide an improved electronic drop safe for receiving cash and validating it, and storing it in a drop safe mode of operation, and to additionally provide an acceptability detection mode of operation in which a piece of currency or a bill can be rapidly and effectively tested to determine if it is acceptable. In this mode of operation, the user inserts the item to be tested, it is tested and then returned to the user regardless of whether it tests as acceptable or not. An indication as to the acceptability of the item is provided to the user who can then decide to accept the currency item with confidence or inform the customer that it cannot be accepted as the case may be. In a presently preferred embodiment, the electronic drop safe is in the acceptability detection mode as a default. Whenever a cashier or other user logs in, the drop safe mode is entered. In alternative embodiments, the cashier or other user can actively select the mode, or the mode may switch automatically based upon the time of day, or some other predetermined condition.

A more complete understanding of the present invention, as well as other features, objects and advantages of the invention, will be apparent from the following detailed description and the accompanying drawings.

### BRIEF DESCRIPTION OF THE DRAWINGS

FIG. 1 is a system diagram showing various aspects of an electronic safe system employing electronic drop safes each of which employs a bill validator in both a drop safe and an acceptability detection mode in accordance with the present invention;

FIGS. 2 and 3 show aspects of an alternative two door electronic safe in accordance with the present invention;

FIG. 4 shows a further alternative embodiment of a portable electronic safe adapted for mobile cash validation and transportation in accordance with the present invention;

FIG. 5 shows further details of the portable electronic safe of FIG. 4;

FIG. 6 shows an exemplary controller for use in conjunction with the electronic safes of FIGS. 1-5;

FIG. 7 shows a coin and bill dispensing safe in accordance with the present invention; and

FIG. 8 shows a process for providing cash acceptability testing independently of an operating mode in cash acceptance and stacking occur in accordance with the present invention.

### DETAILED DESCRIPTION

The present invention now will be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

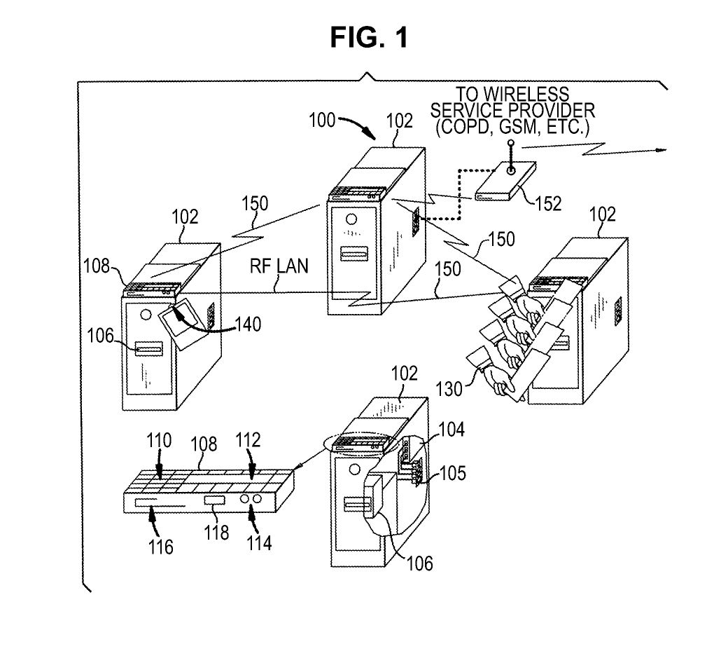

In one aspect, as shown in FIG. 1, the present invention provides an electronic drop safe system 100 comprising a plurality of electronic safes 102. Each electronic safe includes a controller 104 and a bill acceptor or validator 106 for receiving cash deposits. An interface module 108 may include a keypad 110, a display 112, an optical communication port 114, and a radio frequency (RF) local area network (LAN) antenna 116, and an RF identification tag antenna 118. The controller module 104 controls the operation of the electronic drop safe 102, controls the interface module 108, interfaces with the bill acceptor 106, controls all communications, interfaces with a wireless modem 152, and tracks the operation of the safe 102.

External connectors 105 may provide interfaces for power, serial communication, a printer, a phone, a point of sale (POS) terminal, a security camera, and the like. To receive non-cash deposits, the electronic safes 102 may accept envelopes or folders utilizing the bill acceptors 106, or an envelope slot or drawer, not shown, may be employed. A check or other item may be placed in an envelope before insertion into the electronic safe 102. The amount of a check or other item may entered through the keypad 110 or transferred directly from the point of sale terminal utilizing a link from the point of sale terminal or a backroom terminal. Other non-cash media can be inserted into the bill acceptor or envelope slot or drawer, and retained by the electronic safe. This feature dramatically reduces the number of manually handled deposits in most retail establishments.

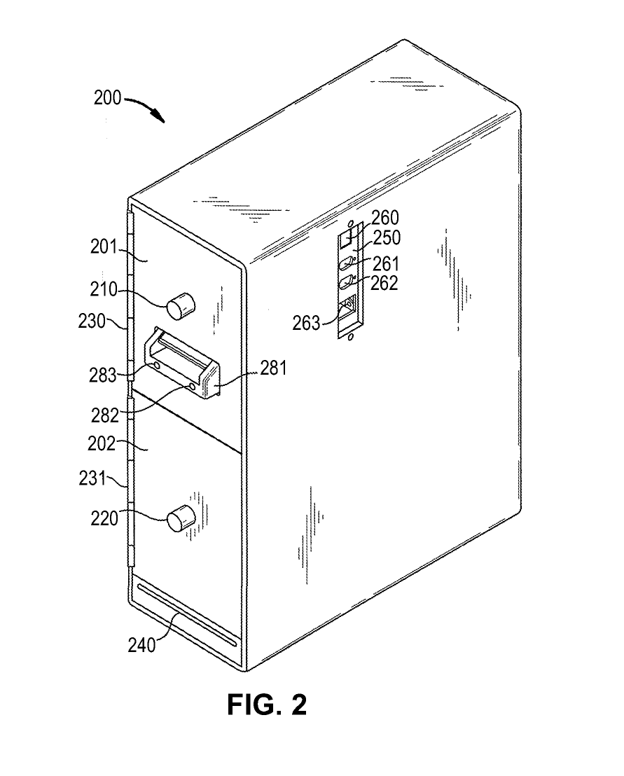

FIGS. 2 and 3 illustrate a further embodiment of an electronic drop safe 200 in accordance with the present invention. An electronic drop safe 200 may suitably be employed as one or more of the electronic drop safes 102 in the system 100 of FIG. 1. The safe 200 is typically made from ⅛″ to ¼″ steel with the doors constructed from ¼″ to ½″ steel. The size of the safe is designed so that it will conveniently fit under a counter near a cash register or POS terminal, although any convenient location is suitable. In a presently preferred embodiment, the safe height will be less than 20″, its width about 6″, and its depth about 15″.

The electronic drop safe 200 is equipped with at least two doors 201 and 202 as shown in FIGS. 2 and 3. Doors 201 and 202 provide independent access to each of the two major regions requiring access. Upper door 201 provides access to the bill acceptor module and safe electronics. Access thereto is controlled by a lock 210. The lock 210 can suitably be either a mechanical lock requiring a key or an electronic lock requiring a code, key or other access mechanism. Bill acceptor intake 281 extends through the access door 201 and is the inlet for inserting bills to be stored in a secure cassette or for counterfeit testing as described further below.

The bill acceptor entry or intake 281 will typically include indicator lights 282 and 283 to both draw attention to the bill intake region, and to provide some feedback to the user that the bill acceptor is powered and operational. Several manufacturers provide suitable bill acceptor products. One such product is the MEI Cashflow SC Series Bill Acceptor™ product.

The second lower door 202 provides access to the cash canister or stacker. The operation and use of the cash canister will be discussed in further detail below. The cash access door 202 has its own lock 220 which can be mechanical or electronic which is generally keyed or coded differently than the lock 210 in door 201. Door 202 is preferably designed to have minimal or no openings to make forced entry difficult.

In many cases, it is desirable to allow the deposit of cash, checks, food stamps and the like without using the bill acceptor entry 281. To such ends, an envelope drop slot 240 can be provided for this purpose as shown in FIG. 2. In one embodiment, envelopes or items deposited through the envelope drop slot 240 will also presently be accessible through the cash access door 202. Of course, a separate door can be provided for access to the manually dropped items if so desired.

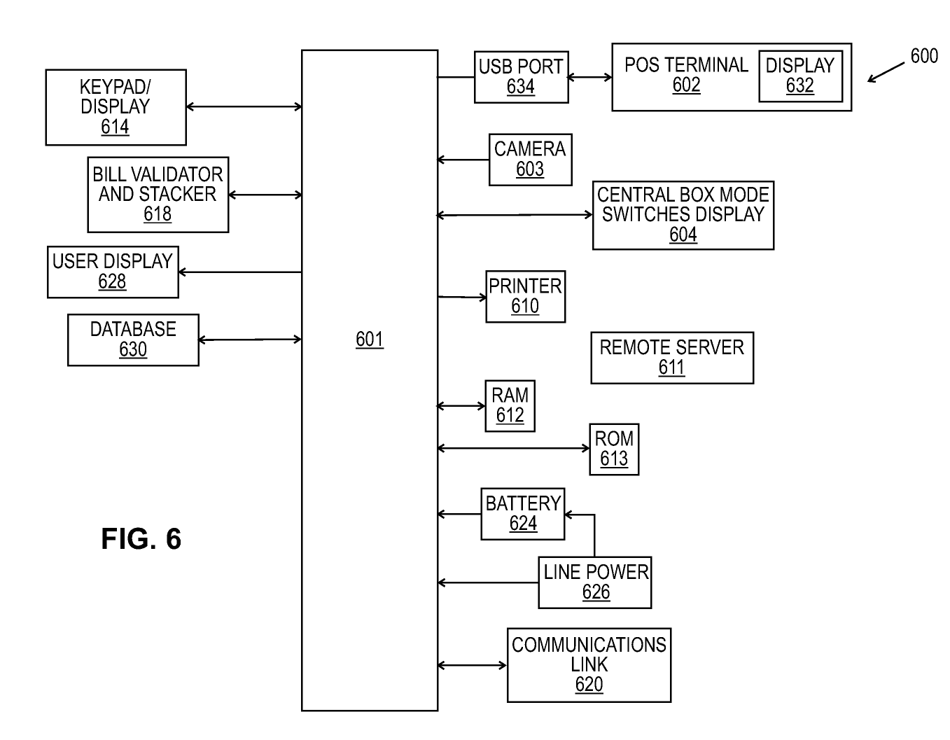

The bill acceptor and other electronic components housed inside the safe 200 require power and control signals to operate. A cable access panel 250 is used to interface the internal components to power and other external components. One such component may be a POS terminal, such as POS terminal 602 shown in FIG. 6. Several types of interfaces can be provided and representative examples of these are shown in FIG. 2. Power for safe operation such as 120 VAC can be provided through an appropriate power connector that would be provided through an opening 263. In many cases, users of the electronic safe will enter their identification code through a separate control box, such as control box 604 of FIG. 6, located conveniently to the user. For example, the control box may sit on a checkout counter next to where the store employee stands. The electronic interface to such a separate control box can be through a connector such as an RJ11 phone style jack mounted in hole 260 or through a connector such as a DB9 computer style connector mounted in hole 261 or hole 262. The exemplary control box 604 shown in FIG. 6 in accordance with the present invention includes an acceptability mode selector 606 and a drop mode selector 608. Additional connections to peripheral devices such as a printer 610, the POS terminal 602 or a backroom computer 612 can also be made through connectors mounted in one of several openings such as the holes 260, 261, or 262. It should be clear that the number of openings provided for connectors can vary by application and need not be limited to those shown. It should also be clear that the external control box could include sophisticated electronics or be limited to a keypad, a touch display or both. Also, the display and keypad can be mounted atop the safe and interconnected to an internal controller through openings not shown. Additional techniques for providing control signals to allow user access and peripheral interfaces are further described in U.S. patent application Ser. No. 09/960,595 assigned to the assignee of the present invention.

The access doors 201 and 202 are secured to the safe 100 with the use of hinges 230 and 231, respectively. Care must be taken to insure the integrity of these hinges so that they do not allow easy forced entry into the safe. The hinges used in a presently preferred embodiment are designed into the case of safe 200 so that the hinge pins are not accessible from outside the safe.

Referring now to FIG. 3, the safe 200 of the current invention is shown with both doors 201 and 202 open. Mounted inside the safe is a bill acceptor unit 300 which consists of three major sections. These major sections are a bill acceptor module 301, a mounting frame 302 and a cash canister 303. The mounting frame 302 is securely fastened into the safe body. Depending on the manufacturer of the bill acceptor, the mounting may vary. Bill acceptor units most suitable to the current invention will have a mounting frame, a bill acceptor module which includes the bill inlet, and a cash canister or cassette module each separately accessible as described herein. Several manufacturers provide such products.

Referring again to the bill acceptor mounting frame 302, the mounting of this module in safe 200 is arranged such that the bill acceptor module is separated from the cash canister module along a dividing plate which is part of the mounting frame 302. This dividing plate is positioned by the safe design to be aligned with the bottom of the top door 201 and the top of the bottom door 202. Further, the cash access door 202 is provided with a reinforcement shelf 270 which is designed to minimize the opening between the bill acceptor module 301 and the cash canister module 303 when the door 202 is closed.

The bill acceptor module 301 can be removed from its frame 302 by lifting a rod 340 which in its downward position locks the bill acceptor module 301 in place inside slots 321. Once the rod 340 is lifted, the bill acceptor module can be removed by pulling outward on the assembly. Once removed, the bill acceptor module 301 preferably allows complete access to the bill path for the purpose of cleaning or clearing jams without the use of tools. Hence, once the bill acceptor module 301 is removed, it can easily be cleaned, cleared or replaced without tools very quickly.

The cash canister 303 is removable from the frame module 302 by pulling outwardly on the cash canister module 303 using its handle 304. It is replaceable by aligning the cash canister module 303 to guide rails, not shown, on the frame module 302 and pushing inward until it snaps in place. The removal and replacement of the cash canister module 303 is fast and simple and requires no additional tools or skills. Further details regarding preferred operation of a two door electronic drop safe as shown in FIGS. 2 and 3 are found in U.S. Pat. Nos. 7,779,983 and 7,516,832 assigned to the assignee of the present application and incorporated by reference herein.

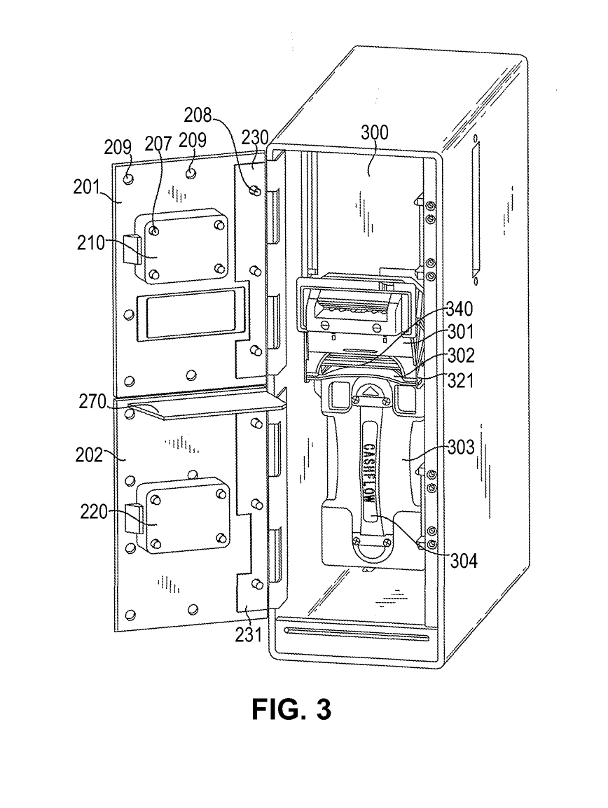

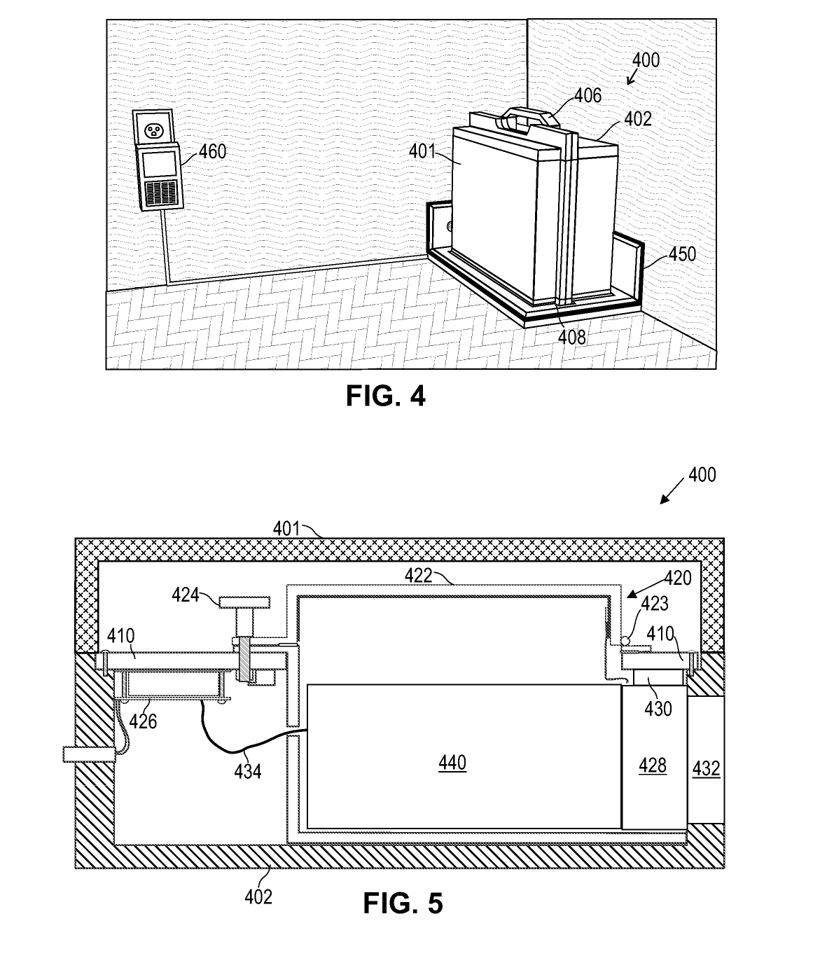

FIGS. 4 and 5 show details of a portable cash transport apparatus 400 in accordance with an embodiment of the invention. The portable cash validation and transportation apparatus 400 may suitably be employed as one or more of the electronic drop safes 102 in the system 100 of FIG. 1. The portable case validation and transportation apparatus 400 has a portable case formed by bottom shell 401 and top shell 402. These shells are preferably made of a durable plastic material that is largely transparent to radio frequency transmissions in the 2.4 GHz band. Preferably, this portable case is light-tight and can maintain a water-tight seal when closed. The case has a handle 406 and a hinge 408 that connects the bottom shell 402 to the top shell 404. The case of portable apparatus 400 is shown closed in a perspective view in FIG. 4. While at the point of sale, the portable apparatus 400 can be further secured in place with the use of a permanently installed docking station 450 as shown in FIG. 4. The docking station 450 can be configured to bolt to the floor, walls, or both. The station may also provide a recharging station to recharge the transport case batteries with the aid of an AC to DC power supply 460.

As seen in FIG. 5, showing an internal cross-section of the portable apparatus 400, a center partition 410 serves as a mechanical mounting surface for all electrical and mechanical subassemblies.

In FIG. 5, a main control board 426 is seen that contains a controller, such as controller 600 of FIG. 6, which may suitably be a programmed microcontroller, microprocessor, FPGA, ASIC, or the like. Controller 600 controls a bill validator 428, which is preferably a combined bill validator and stacker unit. The bill validator 428 is fastened to a center partition 410 with a bracket 430 and is installed such that the bill entry slot 432 is positioned through a rectangular opening in the outer shell of case 100. The validator is connected to the control board 426 utilizing a wire harness 434 so that the value of the cash stored within the validator's cash cassette 440 can be monitored by the controller and reported out over a communication link, such as link 620 shown in FIG. 6. Further details of a presently preferred embodiment of portable cash validation and transportation apparatus 400 are found in U.S. application Ser. No. 14/302,555 filed Jun. 12, 2014, assigned to the assignee of the present invention and incorporated by reference herein in its entirety.

FIG. 6 shows an exemplary control system 600 for use in conjunction with the electronic drop safes 102 of FIG. 1, the electronic drop safe 200 of FIGS. 2 and 3 or the portable cash transport apparatus 400 of FIGS. 4 and 5. Control system 600 includes a programmed microprocessor 601. As seen in FIG. 6, microprocessor 601 communicates with POS terminal 602, camera 603, and control box 604 including acceptability mode selector 606 and drop mode selector 608. Microprocessor 601 also drives printer 610 to generate reports, such as high denomination currency handling reports, by time, denomination and cashier, and may communicate with a backroom computer or remote server 611. Another feature of control system 600 is a keypad, such as keypad 612 shown in FIG. 6. For use in conjunction with apparatus 400, the keypad preferably communicates wirelessly rather than by a wire connection as shown in FIG. 6. Keypad 617 may suitably include a USB port 634, to allow for updating the transport case controller firmware from a file from the USB memory stick, or exporting transport case information utilizing the USB port or connection to a point-of-sale terminal or some other device. Transport case information may include configuration information, or a record of transactions and events. Alternatively, such information may be wirelessly transmitted to a remote location where it can be analyzed to determine busy and slow hours of operation, and the like, as well as, whether a cash pickup or drop-off needs to be made.

Another feature of the keypad 614 is to allow a user to select a drop safe mode or an acceptability testing mode of operation as discussed further below.

Microprocessor 601 has associated memory, such as RAM 612 and ROM 613, and communicates with keypad and display 614, bill validator and stacker 618. A communication link 620 and a universal serial bus 622 may be utilized to communicate with external devices, such as point-of-sale (POS) terminal 602. Microprocessor 601 receives power from a battery 624 or line power 626.

Microprocessor 601 also provides driver signals to a user display 628. The microprocessor 601 also stores and retrieves data from a database 630 of user data and security parameters. For example, database 630 may suitably store user names along with their access codes and permission levels. The database 630 may also store global positioning satellite (GPS) coordinates of valid destination waypoints, and identification numbers of wireless radio keypads, user smart devices or waypoint beacons for use in conjunction with the portable case 400.

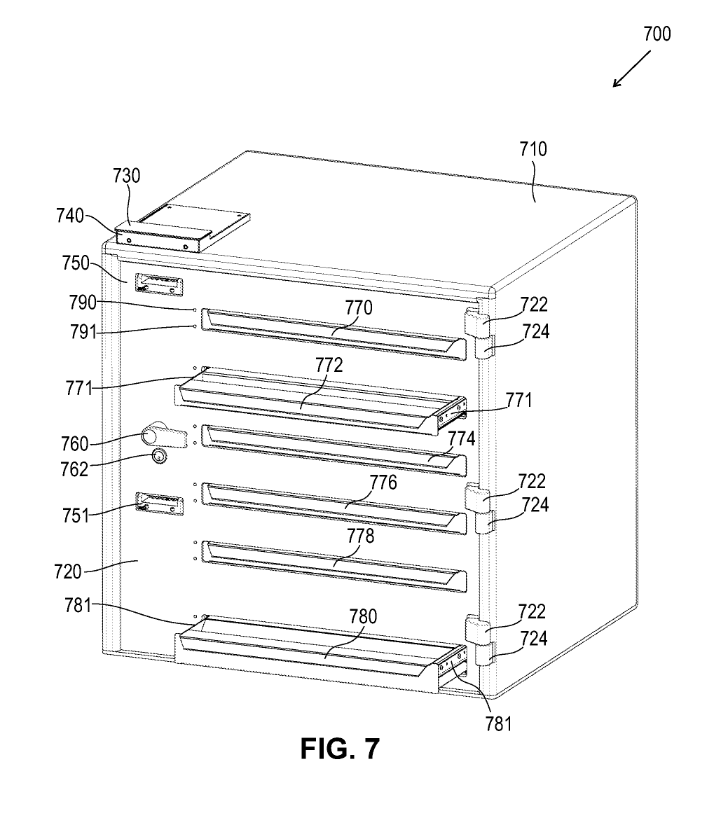

FIG. 7 shows an electronic coin and bill dispensing safe 700 in accordance with the present invention. Safe 700 includes the safe housing 710 and safe door 720. In one configuration of safe 700, the safe housing 710 is made of approximately ¼ inch steel and the safe door 720 is made of ½ inch steel. The safe is preferably a Class B safe. Of course, other materials and gauges can be used as desired or required for a particular context or environment of use. The electronic coin and bill dispensing safe 700 may be suitably controlled by a controller like controller 600 of FIG. 6 adapted to control the coin and bill dispensing functions of the safe 700 as described in further detail in U.S. Pat. No. 8,770,372 assigned to the assignee of the present invention and incorporated by reference herein in its entirety. The safe 700 may be advantageously employed at a customer service desk of a grocery store, large retail store, or the like where high denomination bills can be tested in an acceptability test mode, and bills can be accepted and stacked, and then a corresponding value of coins and bills can be dispensed in a dispense mode.

A user interface is provided through a keypad and display module 740 contained in user interface assembly 730. The material used for the assembly housing is also steel but of a much lighter gauge as a breach of the interface assembly does not allow access to the contents of the electronic safe 700. The keypad and display can both be of any suitably robust type. In a presently preferred embodiment, the keypad is a combination of a membrane overlay with conductive pads attached to a printed circuit board with conductive traces such that a depression of the membrane overlay shorts at least two conductive traces on the printed circuit board indicating the key depression. The display used in the presently preferred embodiment is an LCD display. The choice of keypad and display does not impact the current invention and any of many suitable choices will work. There is a growing trend to use a touch screen LCD or plasma display which is suitable, but currently expensive.

The safe housing 710 is assembled to the safe door 720 through the use of hinge sets 722, 724 including hinges 722 welded to the door 720 and hinges 724 welded to the safe housing 710 as shown in FIG. 7.

The coin and bill dispensing safe 700 can have many trays to store rolls of coins or stacks of bills. Each tray is associated with a pull drawer to allow the user to have access to the coins or bills dispensed. FIG. 7 shows coin trays 770, 772, 774, 776 and 778. In the closed position, only the handle of the pull trays are visible from outside the safe. This is best seen in FIG. 7 relative to drawers 770, 774, 776 and 778 which are shown closed. Drawer 772 is shown in the opened or pulled out state. Each drawer has a pair of sliders 771 with one slider on each side that allow the drawer to be easily extended for access and then slide back to close the drawer. FIG. 7 also shows a bill drawer 780 in its open position exposing its sliders 781.

Access to electrical interfaces is made through an opening in the side 740 or back of the safe enclosure 710. A panel is mounted on the inside of the safe with various connectors that expose the connectors through opening 710. Power, typically 24 VDC, and logic signals, typically RS232, RS485, Ethernet, USB, or an RF antenna will be plugged into this plate (not shown). Further details are found in U.S. Pat. No. 8,770,372 assigned to the assignee of the present invention and incorporated by reference herein in its entirety.

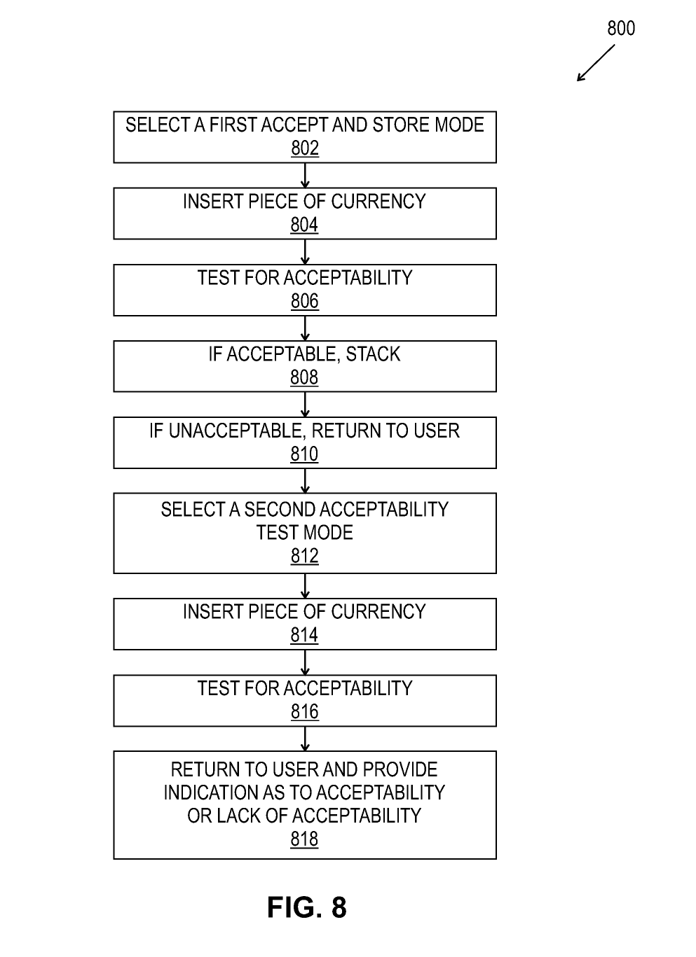

FIG. 8 shows a process 800 of operating an electronic safe in accordance with the present invention. In step 802, a first accept and store mode, or drop mode, of operation is selected. For example, the keypad 110 on the electronic safe 102; a touchscreen of a POS terminal 602 connected to a safe 200, 400, or 700; a selector switch on a counter-top control box 604; or the like, can be used to select this mode. In a presently preferred mode, a cashier uses an identifier, such as an RFID tag, to swipe in. Alternatively, the safes may be programmed to automatically switch modes according to preprogrammed rules as discussed further below. For the drop safes, the accept and store mode will be normal drop safe operation. For the coin and bill dispensing safe, the accept and store mode will be acceptance and storage of currency in normal coin and bill dispensing operation.

With the safe in this first mode, a piece of currency is inserted in step 804. In typical drop safe operation, this piece of currency will be a higher denomination bill, such as a U.S. $20, $50 or $100 bill. While lower denomination bills, such as $1, $5 and $10 bills, may also be dropped in the drop safe, they are more typically added to the cash drawer for reuse in making change.

In step 806, the piece of currency inserted in step 804 is tested for acceptability. For example, the bill acceptor 106, 300, 428, 618, 750 or 751 tests the piece of currency for acceptability. If found acceptable, an acceptability signal is generated and the piece of currency is then stacked in step 810. If the currency fails to be found acceptable, it is returned back to the cashier in step 812.

In step 814, a second acceptability test mode is selected. For example, the keypad 110, the POS terminal touch screen display 632, or the selector switch on the counter-top control box 604 may be used to select the second mode. In step 816, while in the second mode, a further piece of currency is inserted. Typically, the further piece of currency will be a high denomination bill, such as a $20, $50 or $100 bill when the user has concerns about whether it might be counterfeit or not, or the business has a standard operating procedure to test all such bills.

To address such concerns, the acceptability of the piece of currency is tested in step 818. For example, the bill acceptor 106, 300, 428, 618, 750 or 751 tests the piece of currency for acceptability.

In step 820, whether found acceptable or not, the piece of currency is returned to the user and an indication is provided as to its acceptability or lack of acceptability. For example, the display 112, a display on control box 604, or a display screen on the POS terminal touchscreen display 632 indicates the acceptability of the piece of currency to the user. If the piece of currency is not found acceptable, that is similarly indicated to the user.

While a particular order of steps is shown in FIG. 8 for purposes of illustration, it will be recognized that this order is not critical to the invention. For example, in a presently preferred embodiment of the invention, an electronic drop safe has the acceptability test mode as its default mode. When a cashier logs in to use the drop safe in its drop safe mode, for example, for a shift from 11 PM to 7 AM, the controller switches to the drop safe mode in response to the cashier logging in.

One example of operation according to the present invention follows below. In a busy convenience store employing an electronic drop safe 102 or 200, it has been determined that $50 and $100 bills should always be tested for acceptability when the electronic drop safe is not being used in drop safe mode. Finally, it has further been determined that drop safe mode will be employed from 11 PM to 7 AM. Thus, a cashier starting a shift at 7:0 1AM will find the drop safe automatically in acceptability testing mode or will manually select that mode as addressed above.

Any $50 or $100 bills will be tested for acceptability before being placed in the cash drawer of a POS terminal or being returned to the customer as not acceptable. Any $1, $5 or $10 bills will not be tested for acceptability and will go to the cash drawer upon presentation by a customer in payment of a purchase.

In the example given, such operation continues until 11 PM. After 11 PM, the electronic drop safe may automatically transition to drop safe mode or the cashier may manually cause this transition. Between 11 PM and 7 AM, all $20, $50 and $100 bills are dropped according to store rules.

It will be recognized that with appropriate programming, a wide variety of different store operating rules may be routinely supported. For example, a store might want to always drop $50 and $100 bills, and to drop $20 bills during a predetermined period such as between 11 PM and 7 AM. Between 7 AM and 11 PM, $20 bills might be tested for acceptability before acceptance by the cashier and being placed in the cash drawer. Rather than a set policy, a cash management algorithm might dynamically determine which bills above a predetermined denomination, such as a $10 bill, can be accepted and whether they are to go in the cash drawer or the drop safe.

In accordance with another aspect of the present invention, by providing the appropriate interface from the bill acceptor to the controller with access through either a serial port, IRDA port, or other wireless port, an authorized manager can update the bill acceptor with new firmware to allow new or improved currency to be accepted, new or improved anti-counterfeiting techniques to be incorporated, or any changes required within the safe controller to be updated without the need to open the safe or have access to the currency. Techniques for uploading program memory through wired connections are well known in the art. Further details of presently preferred optical update techniques are described in U.S. Pa. No. 6,643,843, assigned to the assignee of the present invention and entitled “Methods and Apparatus for Optical Communication Update of Program Memory in Embedded Systems”, which is herein incorporated by reference in its entirety. The use of wireless updates, including Blue Tooth™ based techniques, for example, may be particularly suitable when used in conjunction with a local area network as addressed further herein.

If a retailer requires all $50 and $100 bills be dropped directly and immediately into the electronic drop safe, bypassing the POS terminal, the controller 600 can be programmed so that upon detection of an acceptable $50 or $100 bill, the electronic drop safe 100, 200 or 400 automatically switches from acceptability test mode to drop safe mode thereby reducing the opportunity for the cashier to erroneously place these large bills in the cash drawer.

Various reports may be generated as desired using the system 100. As an example, an electronic drop safe in accordance with the present invention may track the number of non-acceptable items presented by the cashier, as well as, the denomination and the time of day of the presentation. Such data can be employed in conjunction with an existing store camera system to quickly index video of people presenting non-acceptable items. With manual review, or facial recognition software, repeat offenders can be identified for future investigation. Further, if a big bill such as a $50 or $100 is placed in the cash drawer instead of the drop safe, a report can indicate which cashier failed to follow a big bill drop policy.

It will be apparent to those skilled in the art that various modifications and variations can be made in the present invention without departing from the spirit and scope of the present invention. Thus, it is intended that the present invention covers the modifications and variations of this invention provided they come within the scope of the appended claims and their equivalents.

I claim:

1. An electronic safe system comprising:
a bill acceptor mounted in an electronic safe operating to test a piece of currency for acceptability;
a storage mechanism mounted in the electronic safe receiving the piece of currency if the piece of currency has tested acceptable when the electronic safe is operating in an accept and store mode;
the bill acceptor returning the piece of currency to a user when the electronic safe is operating in an acceptability test mode; and
an indicator indicating to the user whether the piece of currency is acceptable or not upon return of the piece of currency to the user when the electronic safe is operating in the acceptability test mode.

2. The electronic safe of claim 1 further comprising:
a mode selector to select the accept and store mode or the acceptability test mode.

3. The electronic safe of claim 2 further comprising:
a point of sale terminal connected to the electronic safe and comprising a display as said indicator.

4. The electronic safe of claim 3 wherein the display comprises a touch screen display and the touch screen is employed as said mode selector.

5. The electronic safe of claim 1 further comprising:
a display on the electronic safe utilized as said indicator.

6. The electronic safe of claim 1 further comprising:
a countertop control box connected to the electronic safe and comprising a display utilized as said indicator.

7. The electronic safe of claim 1 further comprising:
a programmed controller providing a report generator to generate a report regarding user handling of high denomination currency.

8. The electronic safe system of claim 1 further comprising:
a programmed controller for controlling the operation of the electronic safe, said controller operating to automatically select the accept and store mode or the acceptability test mode based on preprogrammed rules regarding currency handling.

9. A method of operating an electronic safe system comprising:
operating a bill acceptor mounted in an electronic safe to test a piece of currency for acceptability;
storing the piece of currency in a storage mechanism mounted in the electronic safe if the piece of currency has tested acceptable when the electronic safe is operating in an accept and store mode;
returning the piece of currency to a user by the bill acceptor when the electronic safe is operating in an acceptability test mode; and
indicating to the user whether the piece of currency is acceptable or not upon return of the piece of currency to the user by an indicator when the electronic safe is operating in the acceptability test mode.

10. The method of operating the electronic safe of claim 9 further comprising:
selecting the accept and store mode or the acceptability test mode utilizing a mode selector.

11. The method of operating the electronic safe of claim 10 further comprising:
displaying whether the piece of currency is acceptable or not on a display of a point of sale terminal connected to the electronic safe as said indicator.

12. The method of operating the electronic safe of claim 11 wherein the display comprises a touch screen display and the touch screen is employed as said mode selector.

13. The method of operating the electronic safe of claim 9 further comprising:
utilizing a display on the electronic safe to display said indicator.

14. The method of operating the electronic safe of claim 9 further comprising:
displaying said indicator on a countertop control box connected to the electronic safe.

15. The method of operating the electronic safe of claim 9 further comprising:
generating a report regarding user handling of high denomination currency by a programmed controller.

16. The method of operating the electronic safe system of claim 9 further comprising:
controlling the operation of the electronic safe by a programmed controller, said controller operating to automatically select the accept and store mode or the acceptability test mode based on preprogrammed rules regarding currency handling.
